(19) United States
(12) Patent Application Publication
(10) Pub. No.: US 2006/0291152 A1
(43) Pub. Date: Dec. 28, 2006

(54) Mounting device for flat-panel display

(76) Inventor: Jeff Bremmon, Shakopee, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/446,822

(22) Filed: Jun. 5, 2006

Related U.S. Application Data
(60) Provisional application No. 60/688,356, filed on Jun. 6, 2005.

(51) Int. Cl. G06F 1/16

(52) U.S. Cl. 361/681; 248/917

(57) ABSTRACT

A display mounting assembly mountable to a surface, such as a wall, and having interconnected vertical and horizontal frame elements. The frame of the display mounting assembly having keyholes for attaching displays and a securing assembly for further securing attached displays. The frame may optionally include pivot arms for adjusting the positions of attached displays. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 C.F.R. § 1.72(b).

### CROSS-REFERENCES TO RELATED APPLICATIONS

This application claims priority under 35 U.S.C. § 119 (e) to, and hereby incorporates by reference, U.S. Provisional Application No. 60/688,356, filed Jun. 6, 2005, and under 35 U.S.C. § 120 to, and hereby incorporates by reference, U.S. Design Application Nos. 29/231,516, filed Jun. 6, 2005, 29/231,615, filed Jun. 6, 2005, and 29/231,711, filed Jun. 7, 2005.

### BACKGROUND OF THE INVENTION

1. Field of the Invention

This invention relates to devices for securing displays and, in particular, this invention relates to devices for securing flat panel displays to surfaces, such as walls.

2. Background

Flat panel displays, including plasma-screen television displays, are increasingly present. These displays are sufficiently thin to be mounted conveniently on walls in a manner similar to conventionally framed objects, such as photographs and pictures. Various mounting systems for flat panel displays have been proposed to secure the flat panel displays to a mounting device, the mounting device with its own panel attaching to the back of the flat panel display.

Using mounted devices having a generally solid panel attached to the flat panel display, as in prior devices, is often inconvenient, in part because the solid mounting panel impedes access to the rear of the flat panel display. Access to the rear of the flat panel display is often necessary during installation thereof due to the need to attach and/or access wires, cords, and other interfaces at the back of the display. Indeed, the presence of a generally solid panel on the mounting device creates an impediment to manipulating these wires, cords, and interfaces, especially when the flat panel display is attached to the mounting panel. Further, the solid mounting panel reduces the available space between the back of the flat panel display and the adjacent wall to which the flat panel display is attached, thus making it difficult to store wires and cords directly behind the flat panel display, where the wires and cords can be conveniently kept out of sight, as seen from the front of the flat panel display.

Additionally, the wall engaging portion of the prior display mounting devices is typically a substantially solid, rigid and flat panel. Panels of this nature require any in-wall wiring to exit above, below, or to the side of the panel. Alternatively, the panel must be cut to provide a relief for routing wiring. The construction of the wall to which the mounting device is to be attached and wiring locations within the wall, however, may effectively dictate the wall exit location for the wiring, thereby making it more difficult to provide an exit location, which is concealed behind the flat panel electronic display device as may be desirable for aesthetic reasons. On the other hand, cutting a relief into the mounting panel may weaken the panel structurally and may, itself, be unsightly.

Moreover, flat panel electronic displays, particularly plasma displays, may weigh more than one hundred pounds, thereby causing a significant moment force to be exerted on the wall at the points of attachment. When mounted in public areas, the displays may be subject to contact, further causing an even greater load on the wall and wall structure. One drawback with the prior art of mounting devices for flat panel displays is that these mounting devices typically attach to the wall construction along a relatively narrow horizontal band, thereby concentrating the load in a small area of the wall. The result of attaching these mounting devices along a relatively narrow horizontal band on a wall is that of sometimes overloading and failure of the wall construction or mount, thereby causing damage to the electronic display and possibly injury to persons nearby.

There is thus a need in the industry for a mounting device addressing the aforementioned drawbacks by enabling improved access for cable routing and by providing improved load distribution on the structure supporting the flat panel electronic display and mount.

### SUMMARY OF THE INVENTION

This invention substantially meets the aforementioned needs of the industry by providing a flat panel display device enabling improved wiring access and structural load distribution. According to one embodiment of the invention, the mounting device includes a plurality of elongate members coupled in a frame and defining an open interior space. The vertical elongate members confronting the wall surface may have at least one portion set away from the wall surface to facilitate routing of conductors, such as cables and wires, between the vertical elongate members and the wall. These setback portions may be generally concave in some embodiments.

The open interior space defined by the separate elements may enable wiring the exit from the wall at virtually any desired location behind the flat panel electronic display, thereby enhancing concealment of the exit location of the conductors and obviating any need for cutting apertures into the mounting structure. Additionally, elimination of material in the instant structure, as compared to a solid plate, enables a generally lighter and stronger mounting device. The elongate members themselves may be provided with a plurality of apertures to enable a variety of fastener locations, thereby offering greater flexibility in the location to which the instant device is to be mounted.

The spaced-apart location of the elongate members enables the structural load imparted by the flat panel electronic display to be spread over a larger portion of the wall surface, thereby inducing less stress on the wall components. Spread loading of the structural load enables relatively greater loading to be imposed on the mount before wall system failure or damage occurs.

A latch mechanism retaining the flat panel display to the frame is also provided. Alternative embodiments of the invention may include tilt mechanisms for positioning the flat panel display at various viewing angles.

It is therefore an object of this invention to provide a display mounting assembly mountable to a surface and including a frame and a securing device. The frame may have at least one keyhole and a plurality of attachment openings for securing the frame to the surface. Each of the keyholes may have a first portion and a second portion, the second portion opening into the first portion. The first portion may be characterized by a first portion horizontal dimension and the second portion may be characterized by a second portion horizontal dimension, the first portion horizontal dimension being greater than the second portion horizontal dimension. The attachment openings may be positioned outboard each of the keyholes. The securing device may be proximate one of the at least one keyhole and may pivot between an open position and a closed position.

It is therefore another object of this invention to provide a display mounting assembly for attaching a device to the surface and including a frame and a securing device. The frame may be attachable to the surface and may define a plurality of keyholes, each of the keyholes having a first portion opening into a second portion. The first and second portions may each be characterized by a generally horizontal dimension, the first portion horizontal dimension being greater than the second portion horizontal dimension. The first portion may admit a fastener and the second portion may retain the admitted fastener. The securing device may be pivotally attached to the frame proximate one of the keyholes and may further secure the fastener when the fastener is disposed in the keyholes second portion.

It is therefore yet another object of this invention to provide a display mounting device comprising a frame and a securing device. The frame may include a plurality of horizontal frame elements and a plurality of vertical frame elements. Each of the vertical frame elements may have a keyhole and each of the keyholes may further include a first portion, characterized by a first portion horizontal dimension, and a second portion, characterized by a second portion horizontal dimension smaller than the first portion horizontal dimension. The securing device may define a cutout and may be movable between an open position and a closed position, the closed position positioning the securing device over the keyholes second portion.

It is therefore still another object of this invention to provide a method of manufacturing a display mounting device, the method including forming a frame attachable to a surface. The frame may include a plurality of keyholes and at least one securing device. Each of the plurality of keyholes may have an access portion with a maximum horizontal dimension and a notch. The notch may open into the access portion and may have a smaller horizontal dimension than the maximum horizontal dimension of the access portion. The at least one securing device may pivotally be secured to the frame proximate one of the plurality of keyholes. The formed frame may comprise a plurality of horizontal frame elements attached to a plurality of vertical frame elements. The plurality of keyholes and securing device may be disposed on at least one of the plurality of vertical frame elements. Forming the frame may also include attaching a plurality of horizontal frame elements to a plurality of vertical frame elements; and attaching a plurality of pivot arms to the horizontal frame elements or to the vertical frame elements. The plurality of pivot arms may include the plurality of keyholes, the securing device pivotally attached to one of the pivot arms. Forming the frame may yet further include attaching a pivot linkage element between each of the plurality of pivot arms and the vertical frame elements. Forming the frame may still yet further include attaching a plurality of pivot linkage elements between each of the plurality of pivot arms and the vertical frame elements. The frame may be formed such that the pivot arms are simultaneously pivoted and longitudinally translated. The frame may be additionally formed such that the pivot arms may be simultaneously pivoted and displaced away from the horizontal frame elements and the vertical frame elements.

These and other objects, features, and advantages of this invention will become apparent from the description which follows, when considered in view of the accompanying drawings.

### BRIEF DESCRIPTION OF THE DRAWINGS

FIG. 1 is a perspective view of an embodiment of a mounting device of this invention.

FIG. 2 is a rear view of the mounting device of FIG. 1.

FIG. 3a is a front view of the mounting device of FIG. 1.

FIG. 3b is a fragmentary plan view of one embodiment of the instant securing assembly.

FIG. 4 is an end view of the mounting device of FIG. 1.

FIG. 5 is a perspective view of another embodiment of the mounting device of this invention.

FIG. 6 is a front view of the mounting device of FIG. 5.

FIG. 7 is a rear view of the mounting device of FIG. 5.

FIG. 8 is an end view of the mounting device of FIG. 5.

FIG. 9 is a perspective view of another embodiment of the mounting device of this invention.

FIG. 10 is a front view of the mounting device of FIG. 9.

FIG. 11 is a rear view of the mounting device of FIG. 9.

FIG. 12 is an end view of the mounting device of FIG. 9.

FIG. 13 is a side view of the mounting device of FIG. 15 in an open position.

FIG. 14 is a side view of the mounting device of FIG. 15 in a closed position.

FIG. 15 is a perspective view of another embodiment of the mounting device of this invention.

FIG. 16 is a rear view of the mounting device of FIG. 15.

FIG. 17 is a perspective view of another embodiment of the mounting device of this invention.

FIG. 18 is a front view of the mounting device of FIG. 17.

FIG. 19 is a rear view of the mounting device of FIG. 17.

FIG. 20 is an end view of the mounting device of FIG. 17.

FIG. 21 is a side view of the mounting device of FIG. 17 in a closed position.

FIG. 22 is a side view of the mounting device of FIG. 17 in an open position.

FIG. 23 is a perspective view of another embodiment of the mounting device of this invention.

FIG. 24 is a rear view of the mounting device of FIG. 23.

FIG. 25 is a front view of the mounting device of FIG. 23.

FIG. 26 is a side view of the mounting device of FIG. 23 being translated from an open position to a closed position.

FIG. 27 is a side view of the mounting device of FIG. 23 in an open position.

It is understood that the above-described figures are only illustrative of the present invention and are not contemplated to limit the scope thereof.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used to practice the invention, suitable methods and materials are described below. In case of conflict, the present specification, including definitions, will control. In addition, the materials, methods, and examples are illustrative only and not intended to be limiting.

Any references to such relative terms as front and back, horizontal and vertical, or the like, are intended for convenience of description and are not intended to limit the present invention or its components to any specific positional or spatial orientation. All dimensions of the components in the attached figures may vary with a potential design and the intended use of an embodiment of the invention without departing from the scope of the invention.

Each of the features and methods disclosed herein may be utilized separately or in conjunction with other features and methods to provide improved devices of this invention and methods for making and using the same. Thus, a person of ordinary skill in the art will readily appreciate that individual components shown on various embodiments of the present invention are interchangeable without undue experimentation and may be added or interchanged on other embodiments without departing from the spirit and scope of this invention. Representative examples of the teachings of the present invention, which examples utilize many of these additional features and methods in conjunction, will now be described in detail with reference to the drawings. This detailed description is merely intended to teach a person of skill in the art further details for practicing preferred aspects of the present teachings and is not intended to limit the scope of the invention. Therefore, specific combinations of features and methods disclosed in the following detailed description may not be necessary to practice the invention in the broadest sense, and are instead taught merely to particularly describe representative embodiments of the invention.

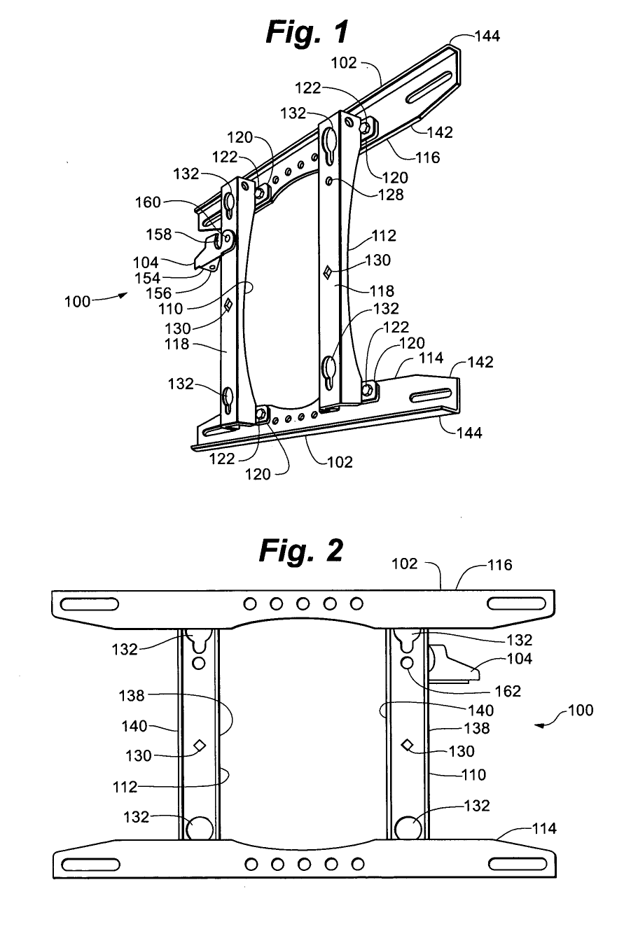

One embodiment of the panel display mounting device of this invention is depicted in FIGS. 1-4 generally at 100 and includes a frame 102 and a securing assembly 104. The frame 102, in turn, has respective first and second vertical frame elements 110 and 112 and first and second horizontal frame elements 114 and 116. Each of the vertical elements 110 and 112 includes a main portion 118 and tab elements 120. The tab elements 120 extend generally laterally from each end of the main portion 118 and define tab apertures 122 therein. The vertical elements 110 and 112 are secured to the horizontal elements 114 and 116 by means of connectors such as threaded shanks 124. In the embodiment shown, the threaded shanks 124 are attached to the horizontal elements 114 and 116, e.g., by press fitting, welding, or the like, and are disposed thereon so as to be accommodated by the tab apertures 122. The vertical frame elements 110 and 112 are secured in place by nuts 126, or other equivalent means. In lieu of the threaded shanks 124 and nuts 126, a person of ordinary skill in the art will readily recognize that other connectors, such as rivets, welds, or machine screws would be suitable for other embodiments of this invention. The vertical frame element main portions 118 may define respective first and second apertures 128 and 130 and a plurality of keyholes 132 disposed proximate the ends thereof. The apertures 128 are depicted as being generally circular and the apertures 130 are shown as generally diamond-shaped. However, a person of ordinary skill in the art will readily recognize that other shapes, e.g. oval, hexagonal, and the like, may be suitable for other embodiments of this invention. The keyholes 132 have an access portion 134 opening into a notch 136. The keyholes 132 may be advantageously utilized with fastening buttons (not shown) attached to items to be mounted therewith, such as a flat panel displays. The keyholes 132 and fastening buttons are disclosed and described in U.S. patent application Ser. No. 10/821,395, hereby incorporated by reference in its entirety. Sides 138 and 140 extend from each of the main portions 118 so as to present a generally U-shaped cross-section. The sides 138 and 140 are generally arcuate in the embodiment depicted, arching upwardly from the ends of the vertical elements 110 and 112. The arcuate shape of the sides 138 and 140 advantageously provide a cutaway portion to enable wires, cables, and the like to be routed between the vertical frame elements 110 and 112 and a surface to which the device of this invention is mounted. While a single cutout is defined by the sides 138 and 140, a person of ordinary skill in the art will readily recognize that the sides 138 and 140 can be configured to define multiple cutouts if desired.

The first and second horizontal frame elements 114 and 116 include generally orthogonal main portions 142 and peripheral lips 144. The main portions 142 define at least one, e.g., five, generally central apertures 146 and a plurality of slots 148. In the embodiment depicted, the slots 148 are generally outboard with respect to the vertical frame elements 110 and 112. The slots 148, along with the apertures 146, are used to mount the instant device to a structural component, such as a wall, by accommodating fasteners such as anchors or lag bolts therein. The horizontal frame elements of this invention are dimensioned so that the slots 148 are spaced apart so as to enable the structural load imposed by flat panel displays to be spread over larger portions of wall surfaces or the like, thereby inducing less stress in these structural components and an enabling relatively greater loading to be imposed on the mount before wall system damage or failure occurs.

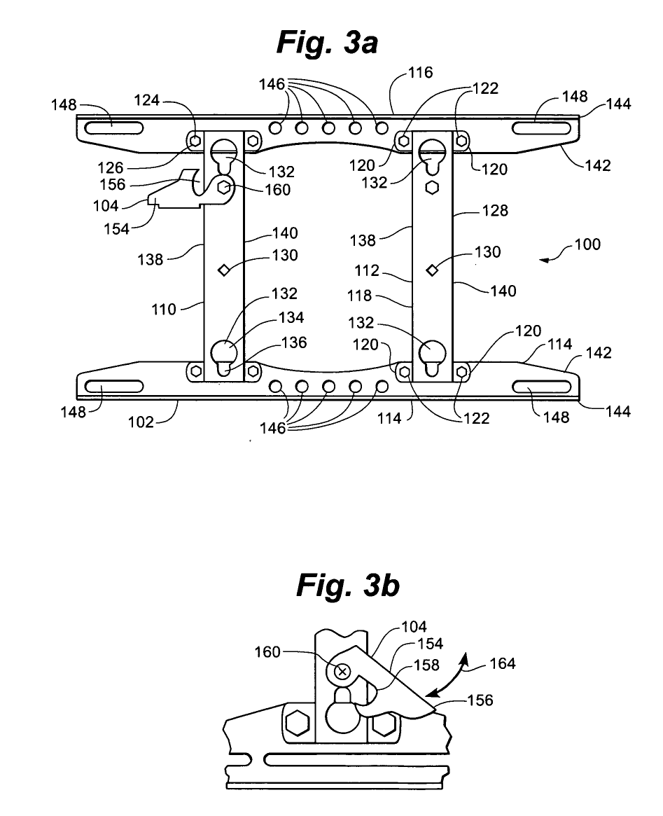

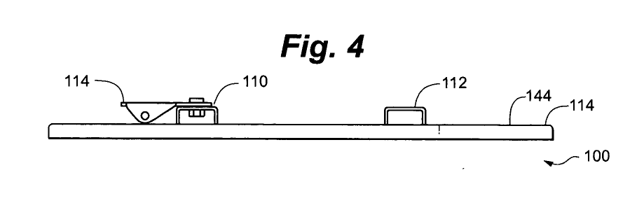

The securing assembly 104 depicted includes a securing element 154, which has a handle portion 156 and defines a cutaway 158. The securing element 154 is pivotally attached to the first vertical element 110 by means of a connector, such as a bolt 160, the bolt 160 secured in place by a nut 162. Alternatively, other connectors, such as rivets or the like, can be used in other embodiments. Fastening buttons as described in U.S. patent application Ser. No. 10/821,395 are further secured in the notches 136 of the keyholes 132 by pivoting the instant securing element 154 from the open position depicted in FIG. 3 to a closed and secured position depicted in FIG. 4 and is depicted by the arrow 164 in FIG. 3b. While the securing element of this invention is shown as attached only to the first vertical frame element 110, a person of ordinary skill in the art will readily recognize that the instant securing element could be attached to the second vertical frame element 112 as well.

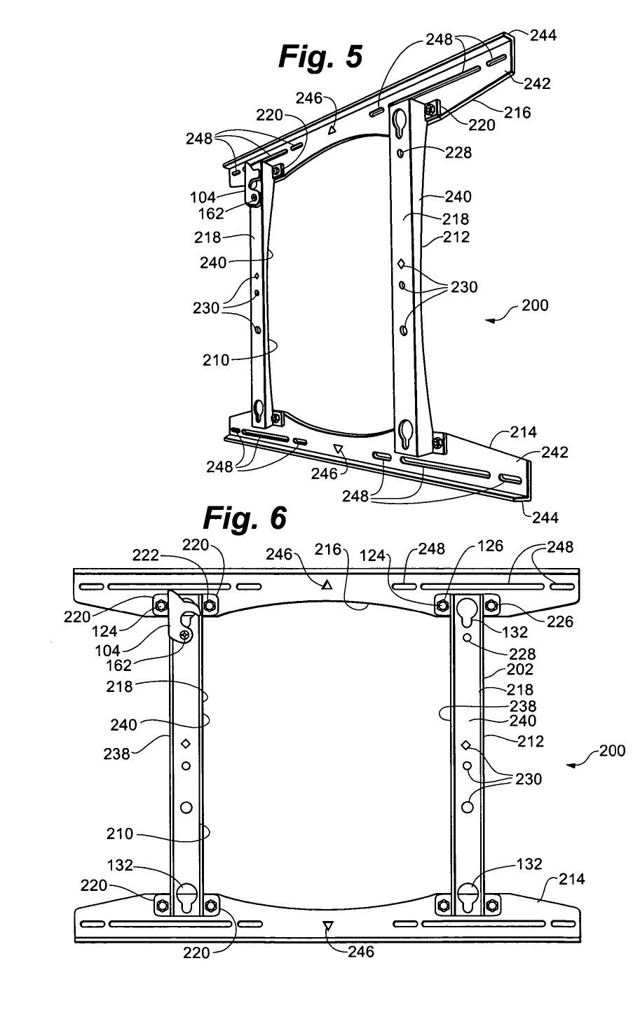

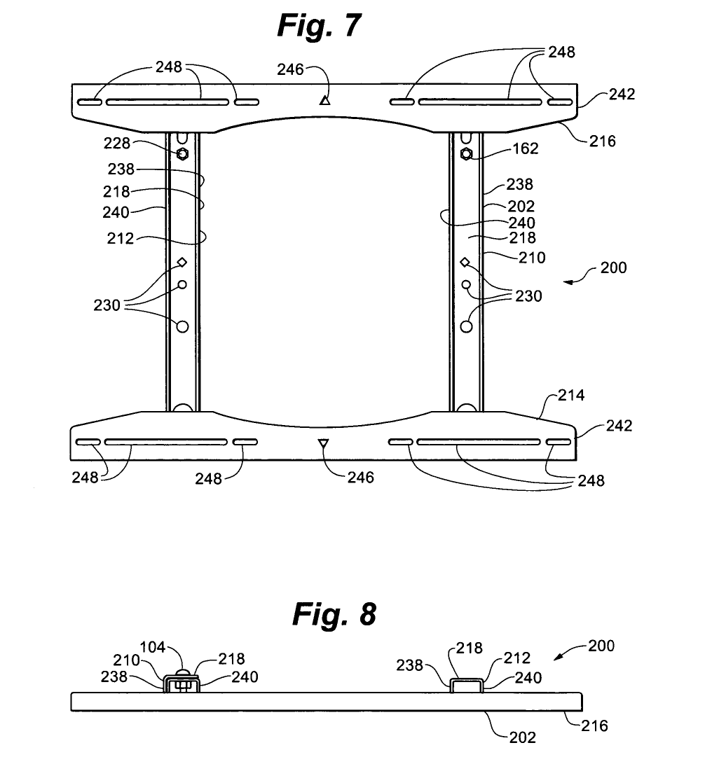

Another embodiment of the mounting device of this invention is shown in FIGS. 5-8 at 200, wherein substantially similar elements to those shown in FIGS. 1-4 and described above are identified by identical numerals. The mounting device 200 includes a frame 202 and a securing assembly, such as the securing assembly 104, with the features and advantages as described above with respect to the mounting device 100. The frame 202 may have respective first and second vertical frame elements 210 and 212 and first and second horizontal frame elements 214 and 216. The first and second vertical frame elements in the embodiment depicted each have a main portion 218 and tab elements 220 extending generally laterally from each end thereof. Each of the tab elements 220 defines a tab aperture 222. The vertical frame elements 210 and 212 are secured to the horizontal frame elements 214 and 216 by connectors such as threaded shanks 124 and nuts 126 or equivalent connectors, as described above. In the embodiment depicted, each vertical frame element main portion 218 defines a first aperture 228 and at least one, e.g., three, second aperture 230. In the embodiment depicted the first aperture 228 is generally circular and the second apertures 230 are circular or diamond-shaped. However, a person of ordinary skill in the art will readily recognize that other shapes, e.g., square, hexagonal, may be present as desired. Sides 238 and 240 extend generally orthogonally from each main element 218 in this embodiment. The sides 238 and 240 are generally and advantageously arcuate as described above with respect to the first and second vertical frame elements 110 and 112. Additionally, the vertical frame elements of this embodiment may have the same variations in features and the same, or similar, advantages as discussed above with respect to the first and second vertical frame elements 110, 112.

The first and second horizontal frame elements 214 and 216 each have a main portion 242 and a peripheral lip 244. Each main portion 242 defines at least one aperture 246 and a plurality, e.g. six, slots 248. In the embodiment shown the aperture 246 is generally triangular; however, a person of ordinary skill in the art will readily recognize that other shapes, e.g., circular, square, hexagonal, may be present as well. The slots 248 are disposed outboard the aperture 246. The apertures and slots of these and other embodiments in the instant horizontal frame elements are dimensioned and disposed to attach the mounting device 200 to a structural surface, such as a wall, in the manner, and with the advantages, discussed above with respect to the mounting device 100.

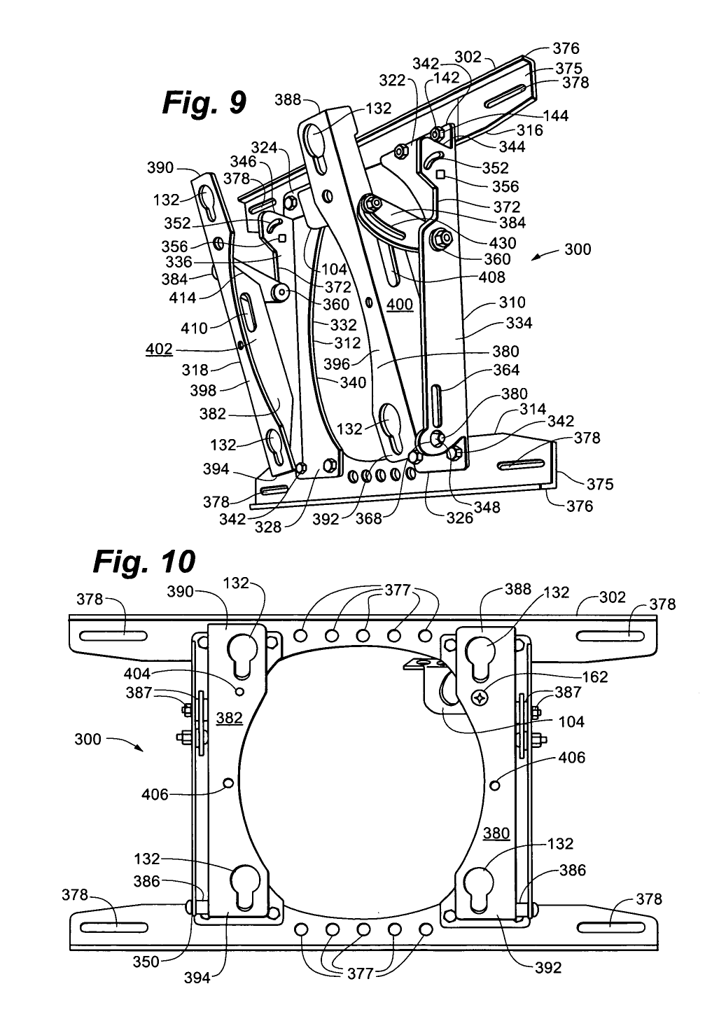

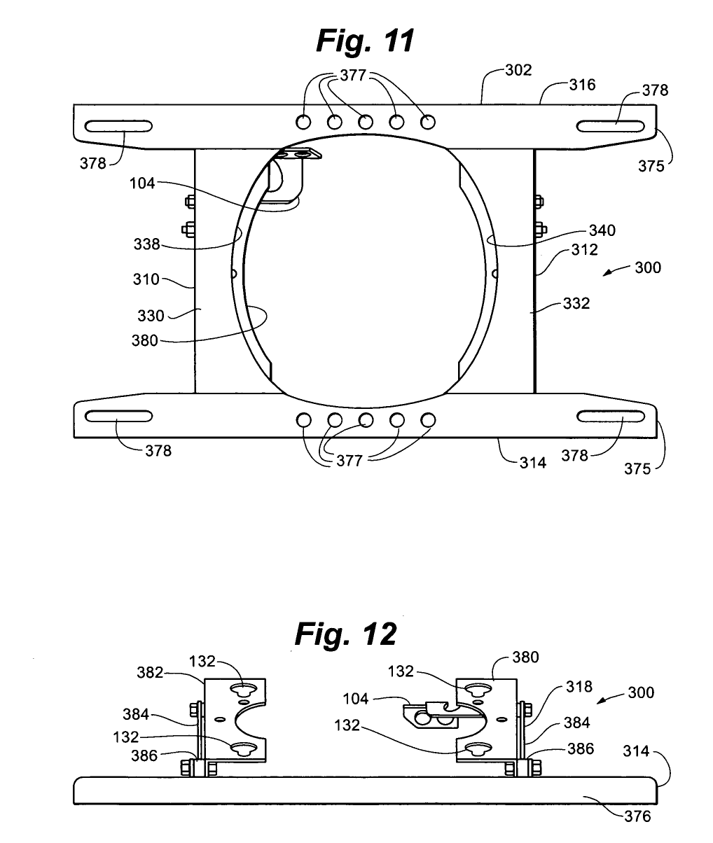

Referring to FIGS. 9-12, yet another embodiment of the mounting device of this invention is shown generally at 300 and includes a frame 302 and a securing assembly, such as indicated, and with the advantages discussed, above with respect to the securing assembly 104. Certain aspects of the frame 302 and other frames disclosed herein are disclosed and described in U.S. Pat. No. 6,402,109, issued 11 Jun. 2002, hereby incorporated by reference. The frame 302 includes respective first and second vertical frame elements 310 and 312, first and second horizontal frame elements 314 and 316, and a pivoting assembly 318. In the embodiment shown, the vertical frame elements 310 and 312 are mirror images of each other, characterized by respective first ends 322 and 324, second ends 326 and 328 and having respective front portions 330 and 332 generally orthogonally joining outboard portions 334 and 336 and inboard edges 338 and 340. The inboard edges 338 and 340 impart a generally concave shape to the front portions 330 and 332. Consequently, the front portions 330 and 332 taper from maximum widths at their front ends 322 and 324 to minimum widths proximate the midpoints thereof. Apertures 342 are defined proximate the first ends 322 and 324 and the second ends 326 and 328 of the front portions 330 and 332. Connectors, such as the threaded shanks 124 and nuts 126 may be disposed on the horizontal frame elements 314 and 316 as discussed above with respect to the mounting device 100 and alternative means of affixing the vertical frame elements 310 and 312 to the horizontal frame elements 314 and 316, as also discussed above with respect to the mounting device 100, may also be employed.

The outboard portions 334 and 336 may be characterized by respective first ends 344 and 346 and second ends 348 and 350. Proximate the first ends 344 and 346, and proceeding toward the second ends 348 and 350, are respective curved slots 352, first apertures 356, second apertures 360, generally linear slots 364, and third apertures 368. Peripheral cutouts 372 are disposed between the first apertures 356 and the second apertures 360.

The first and second horizontal frame elements 314 and 318 are mirror images of each other in the embodiment depicted and may include a main element 375 and a peripheral lip 376 extending generally orthogonally from the main element 375. The main element 375 may define at least one, e.g., five, generally central apertures 377 and a plurality of slots 378 disposed outboard the apertures 377. A person of ordinary skill in the art will readily recognize that the apertures, while depicted as being circular, can be made in a variety of shapes as discussed above. The utility and locations of the slots 378 may be similar, or substantially the same as, the slots 148 discussed above with respect to the mounting device 100.

The pivoting assembly 318 has respective first and second pivot arms 380 and 382, pivot link elements 384, spacer/friction elements 386, and spacer/friction elements 387. A pivot linkage element 384 links the first and second pivot arms 380 and 382 to the first and second vertical frame elements 310 and 312. The first and second pivot arms 380 and 382 may be characterized by respective first ends 388 and 390 and second ends 390 and 392, a spacer 386 being operably positioned between the second ends 390 and 392 of the first and second pivot arms 380 and 382 and the outboard portions 334 and 336 of the first and second vertical elements 310 and 312.

The first and second pivot arms 380 and 382 may include rear portions 396 and 398 and outboard portions 400 and 402 extending generally orthogonally from the rear portions 396 and 398. The rear portions 396 and 398 further define first apertures 404 and second apertures 406. A plurality of keyholes such as those indicated at 132 may also be defined in the rear portions 396 and 398 and are depicted in the figures as being disposed proximate the first end 388 and 390 and the second ends 392 and 394. The keyholes 132 and their features and advantages are discussed above with respect to the mounting device 100. A securing assembly such as that indicated at 104 and discussed above with respect to the mounting device 100 may be pivotally mounted to one or both of the rear portions 386 and 388 using one or both of the apertures 404. Slots 408 and 410 are defined in the respective outboard portions 400 and 402 proximate first ends 412 (first end 412 not shown) and 414 thereof and apertures 416 and 418 (not shown) are defined proximate second ends 420 and 422 (not shown) thereof.

Each of the pivot linkage elements 384 may define a generally curved slot 430 proximate one end thereof and an aperture 432 (not shown) disposed proximate the other end thereof.

The spacers (or friction washers) 386 may be made from such suitable materials is ultra-high molecular weight polyethylene (UHMWPE) or ultra-high density polyethylene (UHDPE). However, a person of ordinary skill in the art will readily comprehend that the instant spacers may be made from other materials, such as wood or other synthetic resins, such as disclosed and described in the Handbook of Plastics, Elastomers, and Composites, Third Edition, Charles A. Harper, Editor in Chief, McGraw-Hill (1996), hereby incorporated by reference.

The pivoting assembly 318 is assembled connecting the first and second pivot arms 380 and 382 to the first and second vertical frame elements 310 and 312. Assembly is accomplished by first securing a connector, such as a nut and bolt or rivet, through the second apertures 360 and 362 of the outboard portions 334 and 336 and the apertures 432 of the pivot linkage elements 384, friction elements 387 being disposed between the outboard portions 400 and 402 and the pivot linkage elements 384 and between the pivot linkage elements 384 and the connector, to thereby establish pivot points 434 and 436 (pivot point 436 not shown). Second securing a connector, such as a nut and bolt or rivet, through the curved slots 430 of the pivot linkage elements 384 and the apertures 416 and 418 of the outboard portions 400 and 402; and third by securing a connector, such as a nut and bolt or rivet, through the third apertures 368 and 370 of the outboard portions 334 and 336, the spacers 386, and the apertures 416 and 418 of the outboard portions 400 and 402 to establish pivot points 438 and 440 (pivot point 440 not shown).

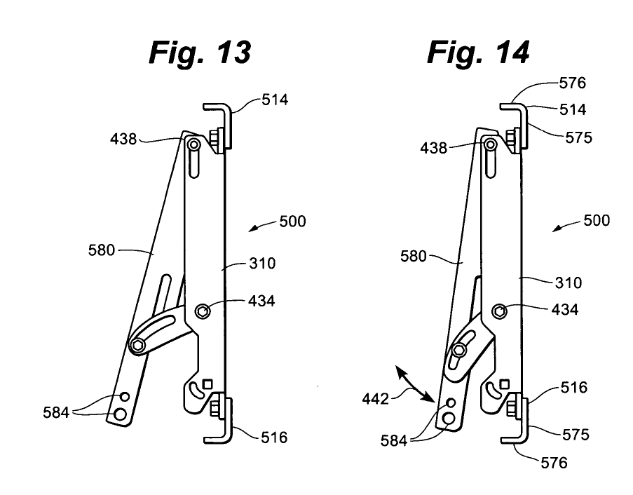

Referring to FIGS. 9, 13 and 14, the pivot arms 380 and 382 of the assembled pivoting assembly 318 are pivoted away from, and toward, the remainder of the mounting device 300 at the pivot points 438 and 440 as indicated by the arrow 442. As the pivot arms 380 and 382 are pivoted, the pivot linkage elements 384 are pivoted at pivot points 434 and 436 as the connectors slide within the curved slot 430 of the pivot linkage elements 384. Resistance to pivoting is imparted by the friction elements 386 and 387. This resistance tends to maintain the pivot arms 380 and 382 at positions intermediate between those depicted in FIGS. 13 and 14. Resistance to pivoting also imparts the tendency to maintain pivot arms of other embodiments of this invention when other friction elements are present.

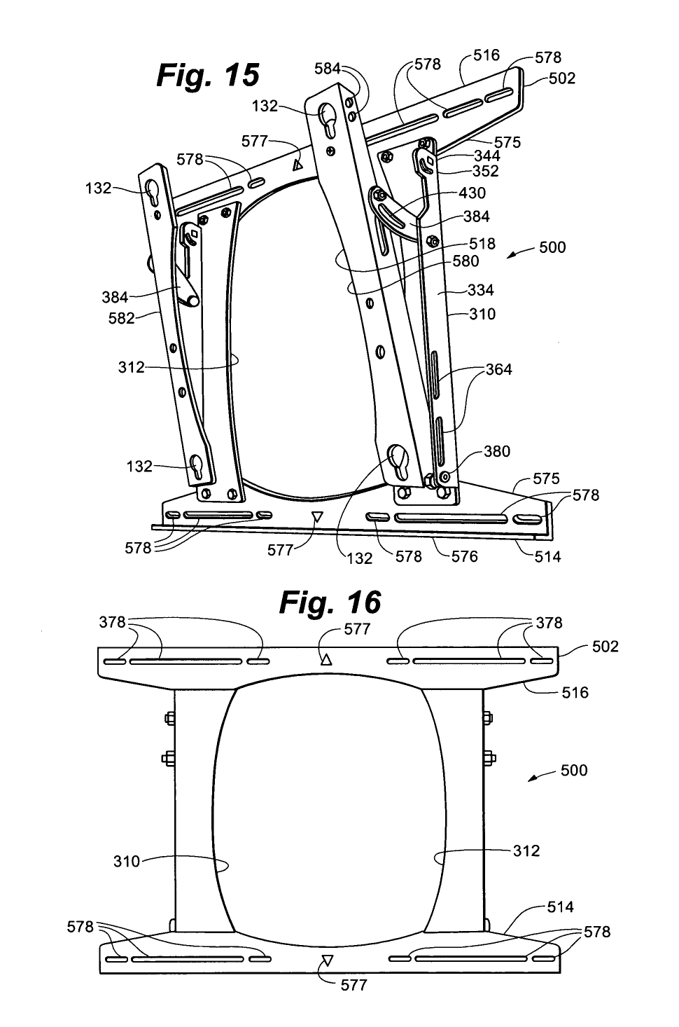

Yet another embodiment of the mounting device of this invention is shown in FIGS. 13-16 generally at 500. The mounting device 500 includes a frame 502 and a securing assembly such as that indicated at 104 and discussed above with respect to the mounting device 100. The frame 502 includes first and second vertical frame elements 310 and 312, first and second horizontal frame elements 514 and 516, and a pivoting assembly 518. The horizontal frame elements 514 and 516 each have a main portion 575 and a peripheral lip 576, differing from the horizontal frame elements 314 and 316 by defining a generally central aperture 377 and a plurality of slots 378 disposed generally outboard the aperture 377. While the aperture is shown as being generally triangular, apertures of other shapes may be used in other embodiments as discussed above. The plurality of slots are advantageous for mounting the mounting device 500 on surfaces in situations where it is desirable to fasten the device at several places on the surface, the slots allowing connectors to be extended into structural members, such as vertical studs. The pivoting assembly 518 may include the components described above with respect to the mounting device 300, but with first and second pivot arms 580 and 582 in place of the first and second pivot arms 380 and 382. The pivot arms 580 and 582 differ from the pivot arms 380 and 382 by defining at least one, e.g., two, apertures 584. In this embodiment, the handle portion 156 (not shown) of the securing element 154 has one or more apertures (not shown) aligning with the apertures 584 when the securing element 154 is in the closed position. Thus, the securing element 154 can be further secured in the closed position by securing a connector, such as a nut and bolt or a rivet, though the aligned apertures or securing a hasp of a lock through the aligned apertures.

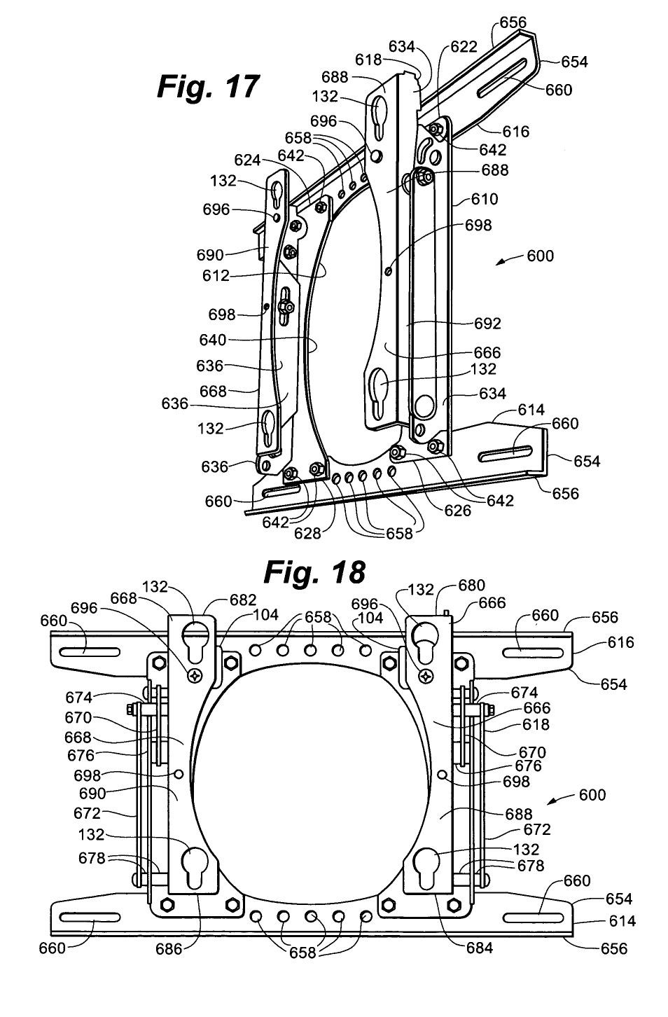

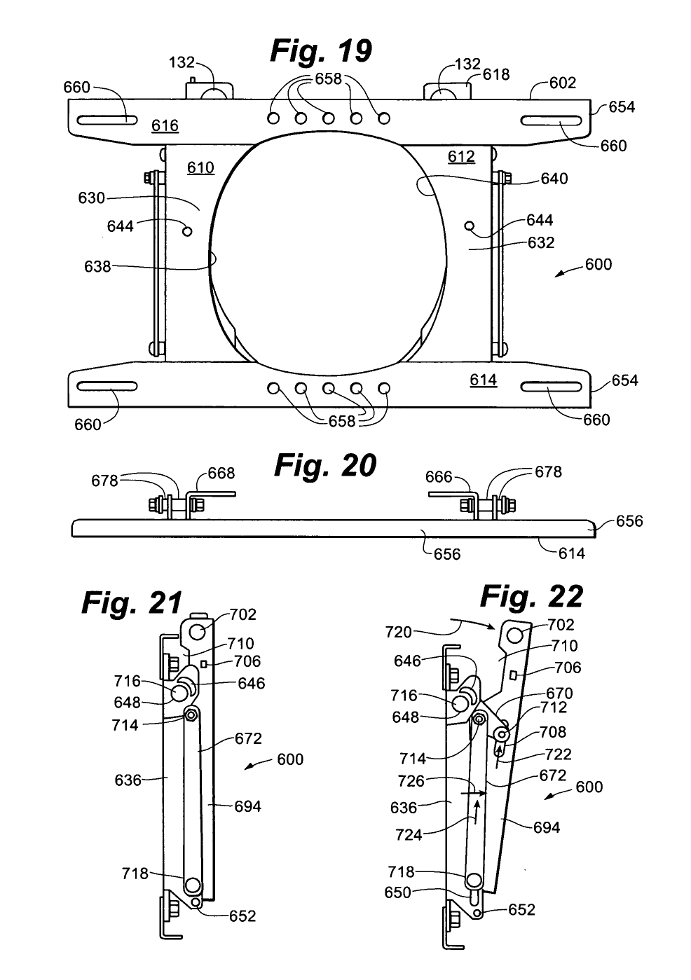

Another embodiment of the instant mounting device is shown in FIGS. 17-22 and is indicated generally at 600. In the embodiment depicted, the mounting device 600 includes a frame 602 and may include a securing assembly, such as the securing assembly 104 discussed above with respect to the mounting device 100. The frame 602, in turn, may include respective first and second vertical frame elements 610 and 612, first and second horizontal frame elements 614 and 616, and a pivoting assembly 618.

The first and second vertical frame elements 610 and 612 may be characterized as having respective first ends 622 and 624 and second ends 626 and 628. Each of the vertical frame elements 610 and 612 has respective front portions 630 and 632 and outboard portions 634 and 636 extending generally orthogonally from the front portions 630 and 632. Generally arcuate inboard edges 638 and 640 are opposite the respective outboard portions 634 and 636 on the respective front portions 630 and 632. In the embodiment shown, the front portions 630 and 632 taper from maximum widths at first ends 622 and 624 and at second ends 626 and 628 to minimum widths at their mid-points therebetween. Apertures 642 are defined in the front portions 630 and 632 proximate the first and second ends thereof and apertures 644 are defined generally centrally therein. The apertures 642 are disposed and dimensioned to accept connectors, such as threaded shanks extending from the first and second horizontal frame elements 614 in 616. The first and second frame elements 610 and 612 may be secured to the first and second horizontal frame elements 614 and 616 by nuts threaded on the connectors. A person of ordinary skill in the art will readily comprehend alternate structure, e.g., rivets, welds, and the like, to affix the instant vertical frame elements to the instant horizontal frame elements. Each of the outboard portions 634 and 636, beginning proximate the first ends thereof, define generally curved slots 646, first apertures 648, generally linear slots 650, and second apertures 652. The first and second horizontal frame elements 614 and 616, being mirror images in the embodiment shown, have main portions 654 and a peripheral lip 656 extending generally orthogonally from each main portion 654. The main portions 654, in turn, define generally central apertures 658 and slots 660. The slots 660 are disposed proximate each end of the main portions 654 in the embodiment shown.

The pivot assembly 618 may include respective first and second pivot arms 666 and 668 and, in mechanical communication with each pivot arm, respective first and second pivot linkage elements 670 and 672 and respective first, second, and a pair of third spacer/friction elements 674, 676, and 678. The pivot arms 666 and 668 may be characterized by respective first ends 680 and 682, second ends 684 and 686, and have respective rear portions 688 and 690 and outboard portions 692 and 694 extending generally orthogonally from the rear portions 668 and 690, respectively. The rear portions 688 and 690, in turn, define respective first and second apertures 696 and 698 and may have keyholes 132 defined proximate each of the first and second ends thereof. Securing structures, such as described above with respect to the securing assembly 104, may be operably affixed to the rear portions 688 and 690 by securing connectors through the first apertures 696. In the embodiment shown, the second apertures 698 are defined generally centrally on the rear portions 688 and 690. The keyholes 132 are discussed above with respect to the mounting device 100. The outboard portions 692 and 694 are generally mirror images of each other and define respective first, second, and third apertures 702, 704 (not shown), and 706, slots 708, and cutouts 710. Generally round first and second apertures 702 and 704 are defined proximate the first and second ends of the outboard portions 682 and 694. The third apertures 706 are generally square in the embodiment shown.

The generally elongated first pivot linkage element 670 defines a pair of first apertures (not shown) proximate each end thereof, as well as a second aperture (not shown) positioned between the first apertures. The second pivot linkage element 672 is also generally elongate with a pair of apertures disposed proximate each end thereof.

When the pivoting assembly 618 is assembled, the first and second pivot arms 666 and 668 may be pivoted independently and are longitudinally displaced as they are pivoted away from the horizontal and vertical frame elements. The first and second pivot arms 666 and 668 are initially connected to a first pivot linkage element 670 to establish a first connection 712 by securing a connector through the pivot arm slot 708 and one of the first apertures in the first pivot linkage element 670, a second spacer or friction element 676 being disposed between the pivot arm and the first pivot linkage element. A connector is then secured through the second (middle) aperture of the first pivot linkage element 670 and one of the apertures of the second pivot linkage element 672 to establish a second connection 714, a second space or/friction element 676 disposed therebetween. The first pivot linkage element 670 is then connected to the outboard portions 692 and 694 of the first and second pivot arms to establish a third connection 716 by securing a connector through the other first aperture of the first pivot linkage element 670 and the first aperture 648 in the outboard portions 634 and 636, a first spacer 674 being disposed therebetween. Assembly is then completed by establishing a fourth connection 718 by securing a connector through the other aperture in the second pivot linkage element 672, the slot 650 of the outboard portions 634, 636 and the second aperture 704 of the outboard portions 682 and 694 of the linkage arms, a spacer 678 being present between the second pivot linkage element 672 and the outboard portion 634 and 636 and between the outboard portions 634 and 636 of the vertical frame elements and the outboard portions 692 and 694 of the pivot arms, respectively.

As the pivot arms of this embodiment are displaced away from the frame elements in the direction indicated by the arrow 720, the present pivot arms are also simultaneously longitudinally displaced. Stated otherwise, the linkage arms are pivoted from the closed position of FIG. 21 to the open position of FIG. 22. Simultaneously pivoting away from the frame elements and longitudinal displacement occurs when the first connection 712 is displaced toward the first ends of the pivot arms as the pivot arms are displaced away from the frame elements in the direction of the arrow 722, the first pivot linkage element 670 thereby pivoting on the third connection 716. When the first pivot linkage element 670 is thusly pivoted, the first second connection 714 longitudinally displaces the second pivot linkage element 672 in the direction of the arrow 724. The second pivot linkage element 672 is also simultaneously pivoted at the fourth connection 718 in the direction of the arrow 726. The fourth connection 718 is simultaneously displaced longitudinally in the slot 650, which longitudinally translates the pivot arm.

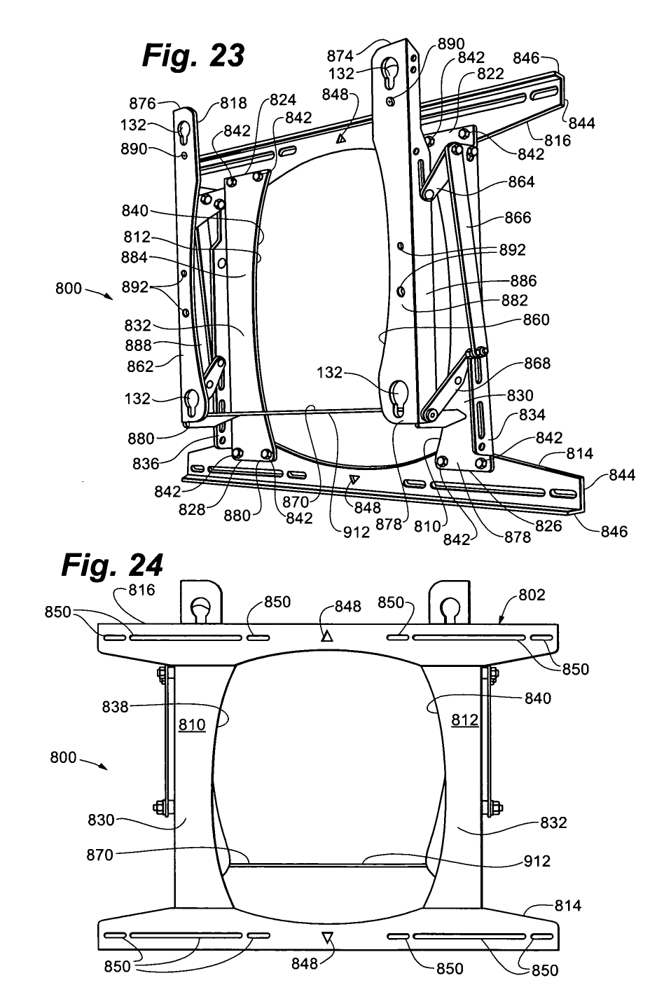

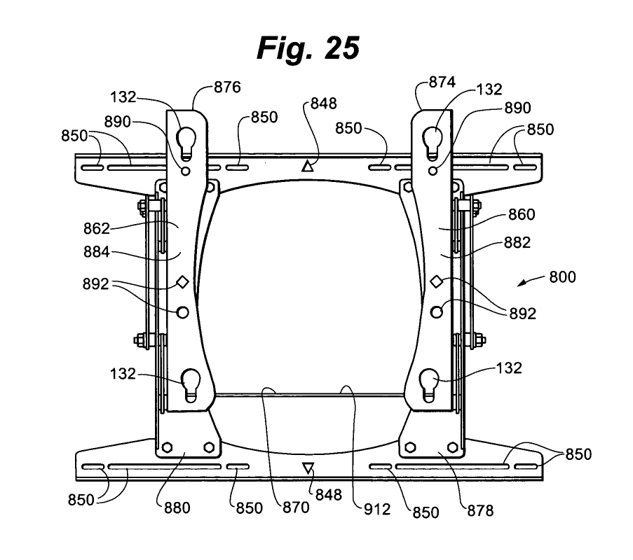

Referring to FIGS. 23-27, yet another embodiment of the mounting device of this invention is shown at 800. The mounting device 800 broadly includes a frame 802 and a securing assembly such as discussed above with respect to the mounting device 100 and indicated at 104.

The frame 802, in turn, has respective first and second vertical frame elements 810 and 812, first and second horizontal frame elements 814 and 816, and a pivoting assembly 818. The generally concave-shaped first and second vertical frame elements 810 and 812 are generally mirror images of each other and, consequently, may be characterized as having respective first ends 822 and 824 and second ends 826 and 828, and have front portions 830 and 832 and outboard portions 834 and 836 extending generally orthogonally from the front portions 830 and 832. The inboard edges 838 and 840 of the respective front portions 830 and 832 are generally arcuate, thereby providing maximum widths proximate the first ends 822 and 824 and the second ends 826 and 828 and providing minimum widths proximate the longitudinal midpoints of the vertical frame elements 810 and 812. Apertures 842 are defined proximate the first ends 822 and 824 and proximate the second ends 826 and 828. The apertures 842 are disposed and dimensioned to accommodate connectors extending from the first and second horizontal frame elements 814 and 816. In one embodiment, the connectors include threaded shanks and the vertical frame elements are affixed to the horizontal frame elements by threading nuts on the connectors. While threaded shanks and nuts are disclosed herein, connectors such as rivets, welds, and the like, may be suitable for other embodiments of this invention.

The first and second horizontal frame elements 814 and 816 are mirror images of each other, each having a main portion 844 and a peripheral lip 846 extending generally orthogonally from the main portion 844. Each main portion 844 defines a generally triangular, central aperture 848; however, apertures of other shapes, e.g., circular, hexagonal, or the like, may be suitable for other embodiments. Each main portion 844 further defines a plurality of slots 850 extending generally longitudinally along the main portions 844.

Referring to the outboard portions 834 and 836, a curved slot is defined therein proximate the second ends 826 and 828 and a plurality, e.g., three, generally linear and longitudinally oriented slots 854 are present as well.

The pivoting assembly 818 has respective first and second pivot arms 860 and 862. Associated with each pivot arm are first second and third pivot linkage elements 864, 866, and 868. An optional pivot arm connecting element 870 may also be present. Additionally, the first, second, and third spacer/friction elements 674, 676, and 678 discussed and described above may be present.

The pivot arms 860 and 862 may be characterized as having first ends 874 and 876 and second ends 878 and 880 and may include respective rear portions 882 and 884 and outboard portions 886 and 888 extending generally orthogonally from the rear portions 882 and 884, respectively. The rear portions 882 and 884, in turn, may each define a first aperture 890 and a plurality of second apertures 892. A securing assembly, such as discussed above with respect to mounting device 100 and designated at 104, may be mounted via one or both of the first apertures 890. One of the second apertures 894 is generally triangular and the other aperture 894 is generally circular; however, a person of ordinary skill in the art will readily recognize that other shapes, e.g., square, diamond-shaped, hexagonal, or the like, may be suitable in other embodiments. Additionally, a keyhole, such as the keyhole 132 discussed above with respect to the mounting device 100, may be present proximate one or more of the first ends 874, 876 and second ends 878, 880.

Each of the outboard portions 886 and 888 may define respective first and second apertures 894 and 896, a slot 898, a third aperture 900 (not shown), and a cutout 902. The cut at 902 may impart a generally tapered appearance to the pivot arms 860 and 862 when viewed from the side. In the embodiment depicted, a pair of first apertures 890 is defined proximate each of the first ends 874 and 876. The second aperture 896 is positioned proximate the cutout 902. The slot 898 extends generally longitudinally proximate the cutout 902. The third aperture 900 is positioned proximate each of the second ends 878 and 880

The first pivot linkage element 864 defines a pair of first apertures 906 (not shown) and a second aperture 908 (not shown). The first apertures 906 are positioned proximate each end of the pivot linkage element 864. The second aperture 908 is positioned proximate one edge of the pivot linkage element 864 and in a position longitudinally intermediate the first apertures 906. The generally elongate second pivot linkage element 866 and third pivot linkage element 868 have an aperture proximate each end thereof. The pivot arm connecting element 870 has a first member 912 and a pair of second members 914, which are mirror images of each other in this embodiment. The second members 914 extend generally orthogonally from each end of the first member 912 and define an aperture (not shown) therein.

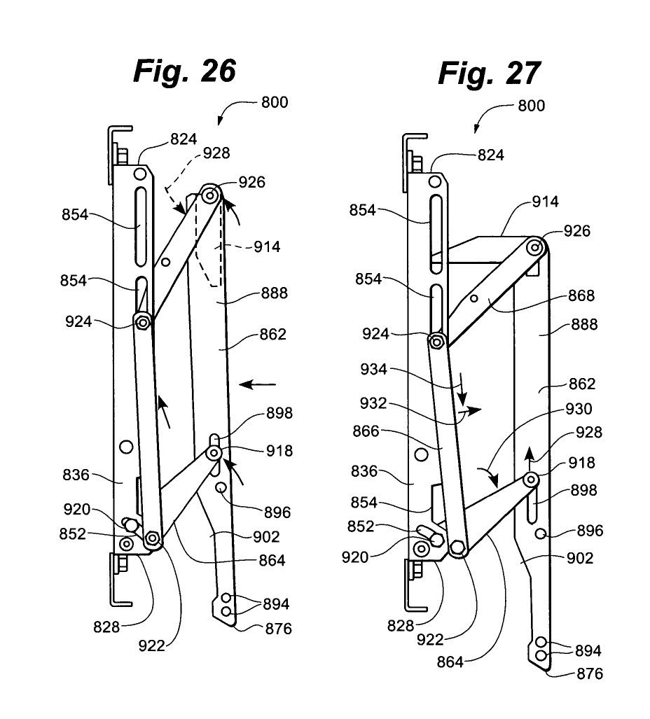

The instant pivoting assembly 818 is operably assembled by establishing a series of pivoting connections as described herein below. A first connection 918 is effected by securing a connector through one of the first apertures 906 of the first pivot linkage element 864 and through the slot 898 of the pivot arms 860, 862, a first spacer/friction element 674 optionally being disposed therebetween. A second connection 920 is established by securing a connector through the other of the first apertures 906 of the first pivot linkage element 864 and through each of the curved slots 852 of the outboard portions 834, 836, a first spacer/friction element 674 optionally being disposed therebetween. A third connection 922 is made by securing a connector in the second aperture 908 of the first pivot linkage element 864 and one of the apertures in the third pivot linkage element 868. A fourth connection 924 is effected by extending and securing a connector in the other aperture of the third pivot linkage element 868, a slot 854 of each outboard portion 834, 836, and one of the apertures present in the third pivot linkage element 868. A fifth connection 926 occurs when a connector is secured in the other aperture of the third pivot linkage element 868, the third aperture 900 in the outboard portions 886, 888, and the aperture of each of the second members 914 of the pivot arm connecting element 870. While the pivoting assembly 818 can be efficiently assembled by establishing the connections in the order as described above, the person of ordinary skill in the art will readily recognize that other iterations may be suitable as well. When installed thusly, the pivot arm connecting element 870 itself pivots between a closed position as depicted in FIG. 26 and indicated by the arrow 928 and an open position depicted in FIG. 27.

Functionally, the pivot arms 860, 862 may be pivoted away from the frame elements from a closed position to a first pivoted position wherein the first ends 874, 876 thereof are forced away from the frame elements while the second ends 878, 880 thereof remain positioned proximate the frame elements. As the pivot arms 860, 862 are pivoted away from the frame elements the first connection 918 is displaced longitudinally in the slot 898 in the direction indicated by the arrow 928, thereby pivoting the first pivot linkage element 864 away from the frame elements and in the direction indicated by the arrow 930. The pivoting first pivot linkage element 864, via the third connection 922, then simultaneously pivots and longitudinally displaces the second pivot linkage element 866 in the directions indicated by the arrows 932 and 934, respectively. From the first pivoted position, the pivot arms 860, 862 may be translated to a second pivoted position depicted in FIG. 27. In doing so the pivot arm second ends 878, 880 are forced away from the frame elements, simultaneously pivoting the third pivot linkage element 868 at the third and fourth connections 922, 924.

The instant pivoting assembly 818, when assembled, simultaneously translates the pivot arms 860 and 862 longitudinally and away from the frame members.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A display mounting assembly mountable to a surface, the mounting assembly comprising:
a frame having at least one keyhole and a plurality of attachment openings for securing the frame to the surface, each keyhole with a first portion and a second portion opening into the first portion, the first portion characterized by a first portion horizontal dimension, the second portion characterized by a second portion horizontal dimension, the first portion horizontal dimension greater than the second portion horizontal dimension, the attachment openings outboard each of said keyholes; and
a securing device proximate one of said at least one keyhole and pivoting between an open position and a closed position.

2. The assembly of claim 1, in which the at least one keyhole is defined on a vertical frame element.

3. The assembly of claim 2, in which the frame comprises a plurality of vertical frame elements and a plurality of horizontal frame elements connected to the vertical frame elements.

4. The assembly of claim 3, in which the securing device is positioned on one of the vertical frame elements.

5. The assembly of claim 3, in which at least one of the plurality of horizontal frame elements comprises an aperture or a slot.

6. The assembly of claim 1, in which the frame comprises pluralities of interconnected horizontal and vertical frame elements and a plurality of pivot arms in mechanical communication with the horizontal and vertical frame elements.

7. The assembly of claim 6, in which the horizontal frame elements comprise structure for attaching the assembly to a surface.

8. The assembly of claim 7, in which the structure for attaching the assembly to a surface comprises an aperture or a slot.

9. The assembly of claim 6, in which the at least one keyhole is defined in at least one of the plurality of pivot arms.

10. The assembly of claim 9, in which the securing device is pivotally positioned proximate one of said at least one keyhole.

11. The assembly of claim 10, in which the frame further comprises a plurality of pivot linkage elements interlinking the pivot arms and the vertical frame elements.

12. The assembly of claim 11, in which the pivot arms are longitudinally translated when the pivot arms are pivoted away from the vertical and horizontal frame elements.

13. A display mounting assembly for attaching a device to a surface, the mounting assembly comprising:
a frame attachable to the surface and defining a plurality of keyholes, each of said keyholes having a first portion opening into a second portion, the first portion admitting a fastener, and the second portion retaining the fastener; and
a securing device pivotally attached to the frame proximate one of the keyholes, the securing device further securing said fastener when said fastener is disposed in said keyhole second portion.

14. A display mounting device, comprising:
a frame including:
a plurality of horizontal frame elements, and
a plurality of vertical frame elements, each of said vertical frame elements having a keyhole, each of said keyholes including a first portion characterized by a first portion horizontal dimension and a second portion characterized by a second portion horizontal dimension which is less that the first portion horizontal dimension; and
a securing device defining a cutout and moveable between an open position and a closed position, the closed position positioning the securing device over the keyhole second portion.

15. A method of manufacturing a display mounting device, comprising:
forming a frame attachable to a surface, the frame including a plurality of keyholes and at least one securing device, each of the plurality of keyholes having an access portion with a maximum horizontal dimension and a notch, the notch opening into the access portion and having a smaller horizontal dimension than the maximum horizontal dimension of the access portion, said at least one securing device pivotally secured to said frame proximate one of said plurality of keyholes.

16. The method of claim 15, in which forming said frame comprises attaching a plurality of horizontal frame elements to a plurality of vertical frame elements, said plurality of keyholes and said at least one securing device disposed on at least one of said plurality of vertical frame elements.

17. The method of claim 15, in which forming said frame comprises:
attaching a plurality of horizontal frame elements to a plurality of vertical frame elements; and
attaching a plurality of pivot arms to said horizontal frame elements or to said vertical frame elements,
said plurality of pivot arms comprising said plurality of keyholes, said securing device pivotally affixed to one of said plurality of pivot arms.

18. The method of claim 17, in which forming said frame further comprises attaching a pivot linkage elements between each of said plurality of pivot arms and said vertical frame elements.

19. The method of claim 17, in which forming said frame further comprises attaching a plurality of pivot linkage elements between each of said plurality of pivot arms and said vertical frame elements.

20. The method of claim 19, in which said frame is formed such that said pivot arms are simultaneously pivoted and longitudinally translated.

21. The method of claim 19, in which said frame is formed such that said pivot arms may be simultaneously pivoted and displaced away from said horizontal frame elements and vertical frame elements.
